(19) United States
(12) Patent Application Publication
(10) Pub. No.: US 2024/0240442 A1
(43) Pub. Date: Jul. 18, 2024

(54) Cable Machine and Jet Line Combination Device

(71) Applicant: Nick Sphar, San Diego, CA (US)

(72) Inventor: Nick Sphar, San Diego, CA (US)

(21) Appl. No.: 18/187,732

(22) Filed: Mar. 22, 2023

Related U.S. Application Data
(60) Provisional application No. 63/438,547, filed on Jan. 12, 2023.

(51) Int. Cl. E03C 1/30; B08B 9/032; B08B 9/043; E03C 1/302; E03C 1/308

(52) U.S. Cl. CPC E03C 1/30; B08B 9/0321; B08B 9/0436; E03C 1/302; E03C 1/308; B08B 2203/0211; B08B 2203/0223; B08B 2203/027; B08B 2203/0276; B08B 2209/032; B08B 2209/04

(57) ABSTRACT

The present invention relates to a cable machine and jet line combination device primarily comprised of a frame with at least one wheel, at least one spool with at least one hose, at least one spool with a snake auger, at least one motor, and at least one pump. The hose of the first spool is preferably a jetter hose that can be used to flush a sewer line. The water pressure within the hose can be increased by the pump which is powered by the motor. The snake auger can be used to further clean sewer lines of debris.

### CROSS-REFERENCE TO RELATED APPLICATION

The present application claims priority to, and the benefit of, U.S. Provisional Application No. 63/438,547, which was filed on Jan. 12, 2023, and is incorporated herein by reference in its entirety.

### FIELD OF THE INVENTION

The present invention relates generally to the field of plumbing tools. More specifically, the present invention relates to a cable machine and jet line combination device primarily comprised of a frame with at least one wheel, at least one spool with at least one hose, at least one spool with a snake auger, at least one motor, and at least one pump. The hose of the first spool is preferably a jetter hose that can be used to flush a sewer line. The water pressure within the hose can be increased by the pump which is powered by the motor. The snake auger can be used to further clean sewer lines of debris. Accordingly, the present disclosure makes specific reference thereto. Nonetheless, it is to be appreciated that aspects of the present invention are also equally applicable to other like applications, devices, and methods of manufacture.

### BACKGROUND

Plumbers use equipment such as cable machines and jet lines during their job. However, said equipment is extremely heavy and difficult to transport. In addition, said equipment may take up a significant amount of limited working space due to its large size.

Therefore, there exists a long-felt need in the art for an improved piece of plumbing equipment. There also exists a long-felt need in the art for a cable machine and jet line combination device that combines the features of both a cable machine and a jet line into one convenient device. Further, there exists a long-felt need in the art for a cable machine and jet line combination device that combines the features of both a cable machine and a jet line into one convenient device, wherein the device can be easily transported and takes up less space than two separate devices.

The subject matter disclosed and claimed herein, in one embodiment thereof, comprises a cable machine and jet line combination device. The device is primarily comprised of a frame with at least one wheel, at least one spool with at least one hose, at least one spool with a snake auger, at least one motor, and at least one pump. The hose of the first spool is preferably a jetter hose that can be used to flush a sewer line. The water pressure within the hose can be increased by the pump which is powered by the motor. The snake auger can be used to further clean sewer lines of debris. Further, at least one secondary wheel and at least one stair climbing roller allow the device to be easily transported and moved up/down stairs and to/from a vehicle.

In this manner, the cable machine and jet line combination device of the present invention accomplishes all the foregoing objectives and provides an improved piece of plumbing equipment that combines the features of both a cable machine and a jet line into one convenient device. Further, the device can be easily transported and takes up less space than two separate devices. This is achieved by the wheels and stair climbing roller of the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable machine and jet line combination device primarily comprised of a frame with at least one wheel, at least one spool with at least one hose, at least one spool with a snake auger, at least one motor, and at least one pump. The frame may be comprised of at least one roll guard that keeps the device steady during use and may also prevent components of the device from becoming damaged if the device falls. Similarly, the components of the device may be protected via at least one cover that can be secured to the frame via at least one fastener.

The frame may also be comprised of at least one axle with at least one (but preferably two) wheels that attach to the axle to allow the device to be easily rolled. The frame may also be comprised of at least one secondary wheel that attaches to the frame via at least one height-adjustable frame. The frame can be secured at a specific height/length via at least one fastener. The secondary wheel can be used to roll the device while laying down and/or allows a user to easily load/unload a device from a vehicle while angling the device.

The frame may also be comprised of at least one stair climbing roller having a wheel and/or belt system that allows the device to be rolled up stairs while in constant forward motion. This prevents the frame from impacting the steps while being pulled. The frame is also comprised of at least one handle that allows the device to be easily moved/manipulated. The handle may be comprised of at least one grip area.

The device also has at least one jet line spool, wherein at least one hose is stored around the spool. The hose is preferably any type of hose or jetter hose known in the art. The hose can be wrapped/unwrapped around the spool via turning at least one handle. At least one snake auger line is also stored on the frame around at least one cable machine spool. The auger is used to remove roots, grease, or any other foreign stoppage inside a sewer/plumbing line. The device is also comprised of at least one motor that may power both spools.

The device may also be comprised of at least one pump used to increase water pressure from a water source that attaches to the jetter hose. The increased water pressure from the pump allows the water from the hose to cut through any excess debris within a sewer/plumbing line, and flush said debris.

Accordingly, the cable machine and jet line combination device of the present invention is particularly advantageous as it provides an improved piece of plumbing equipment that combines the features of both a cable machine and a jet line into one convenient device. Further, the device can be easily transported and takes up less space than two separate devices. This is achieved by the wheels and stair climbing roller of the device. In this manner, the cable machine and jet line combination device provides a novel device for plumbing applications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cable machine and jet line combination device of the present invention in accordance with the disclosed architecture;

FIG. 2 illustrates a side view of one potential embodiment of a cable machine and jet line combination device of the present invention in accordance with the disclosed architecture; and

FIG. 3 illustrates a perspective view of one potential embodiment of a cable machine and jet line combination device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved piece of plumbing equipment. There also exists a long-felt need in the art for a cable machine and jet line combination device that combines the features of both a cable machine and a jet line into one convenient device. Further, there exists a long-felt need in the art for a cable machine and jet line combination device that combines the features of both a cable machine and a jet line into one convenient device, wherein the device can be easily transported and takes up less space than two separate devices.

The present invention, in one exemplary embodiment, is comprised of a cable machine and jet line combination device. The device is primarily comprised of a frame with at least one wheel, at least one spool with at least one hose, at least one spool with a snake auger, at least one motor, and at least one pump. The frame may be comprised of at least one roll guard that keeps the device steady during use and may also prevent components of the device from becoming damaged if the device falls. Similarly, the components of the device may be protected via at least one cover. The cover can be secured to the frame via at least one fastener.

The frame may also be comprised of at least one axle with at least one (but preferably two) wheels that attach to the axle to allow the device to be easily rolled. The frame may also be comprised of at least one secondary wheel. The secondary wheel attaches to the frame via at least one height-adjustable frame that can be secured at a specific height/length via at least one fastener. The secondary wheel can be used to roll the device while laying down and/or allows a user to easily load/unload a device from a vehicle while angling the device.

The frame may also be comprised of at least one stair-climbing roller. The roller has a wheel and/or belt system that allows the device to be rolled up stairs while in constant forward motion. This prevents the frame from impacting the steps while being pulled. The frame is also comprised of at least one handle that allows the device to be easily moved/manipulated. The handle may be comprised of at least one grip area.

The device also has at least one jet line spool, wherein at least one hose is stored around the spool. The hose is preferably any type of hose or jetter hose known in the art that can be wrapped/unwrapped around the spool by turning at least one handle. At least one snake auger line is also stored on the frame around at least one cable machine spool. The auger is used to remove roots, grease, or any other foreign stoppage inside a sewer/plumbing line. The device is also comprised of at least one motor that may power both spools.

The device may also be comprised of at least one pump. The pump can be used to increase water pressure from a water source that attaches to the jetter hose. The increased water pressure from the pump allows the water from the hose to cut through any excess debris within a sewer/plumbing line and flush said debris.

Accordingly, the cable machine and jet line combination device of the present invention is particularly advantageous as it provides an improved piece of plumbing equipment that combines the features of both a cable machine and a jet line into one convenient device. Further, the device can be easily transported and takes up less space than two separate devices. This is achieved by the wheels and stair climbing roller of the device. In this manner, the cable machine and jet line combination device provides a novel device for plumbing applications.

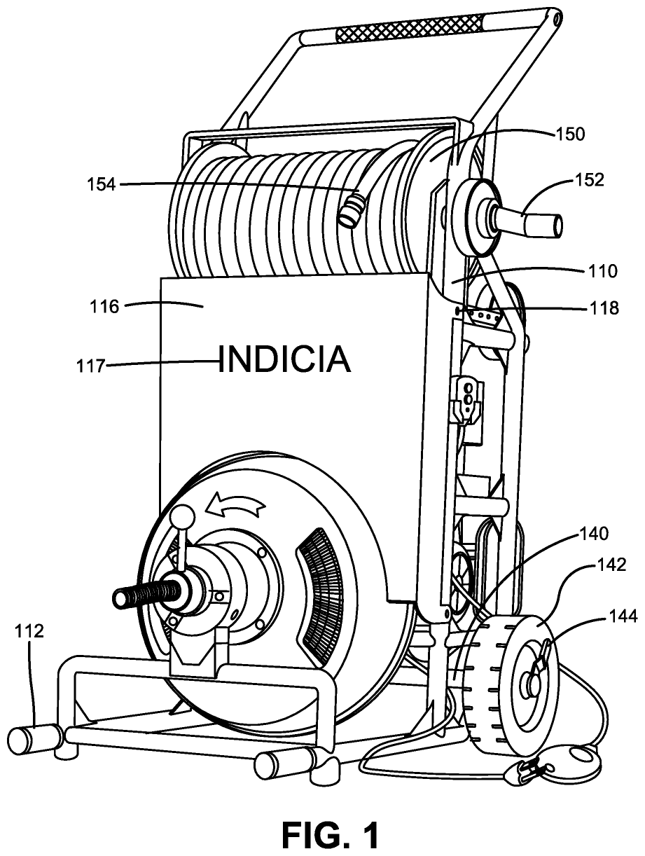

Referring initially to the drawings, FIG. 1 illustrates a perspective view of one potential embodiment of a cable machine and jet line combination device 100 of the present invention in accordance with the disclosed architecture. The device 100 is primarily comprised of a frame 110 with at least one wheel 142, at least one spool 150 with at least one hose 154, at least one spool 162 with a snake auger 160, at least one motor 170, and at least one pump 180. The frame 110 is preferably made from a durable metal material that is corrosion-resistant, such as, but not limited to, stainless steel or aluminum.

The frame 110 may be comprised of at least one roll guard 112. The roll guard 112 keeps the device 100 steady during use and may also prevent components of the device 100 from becoming damaged if the device 100 falls. Similarly, the components of the device 100 may be protected via at least one cover 116 made of the same material as the frame 110 or a rigid plastic. The cover 116 can be secured to the frame 110 via at least one fastener 118 such as, but not limited to, a screw, a bolt, a magnet, etc. The cover 116 may be comprised of at least one indicia 117 such as, but not limited to, a pattern, a logo, a color, an image, words, a brand, etc.

The frame 110 may also be comprised of at least one axle 140. At least one (but preferably two) wheels 142 attach to the axle 140 to allow the device 100 to be easily rolled. The wheel 142 may be locked to prevent movement of the device 100 during use via at least one wheel lock 144.

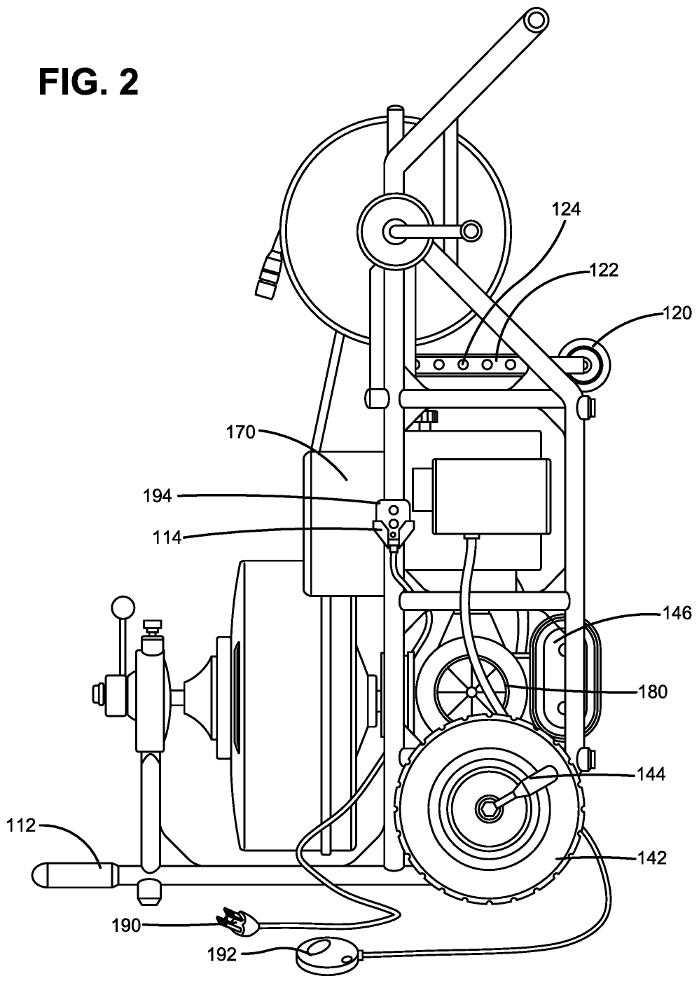

The frame 110 may also be comprised of at least one secondary wheel 120, as seen in FIG. 2. The secondary wheel attaches to the frame 110 via at least one height-adjustable frame 122 that can be secured at a specific height/length via at least one fastener 124 such as, but not limited to, a pin or a nut and bolt assembly. The secondary wheel 120 can be used to roll the device 100 while laying down and/or allows a user to easily load/unload a device 100 from a vehicle while angling the device 100.

To allow the device 100 to be easily pulled up stairs, the frame 110 may be comprised of at least one stair-climbing roller 146. The roller 146 may be comprised of a wheel and/or belt system that allows the device 100 to be rolled up stairs while in constant forward motion. This prevents the frame 110 from impacting the steps while being pulled.

The frame 110 is also comprised of at least one handle 130. The handle 130 allows the device 100 to be easily moved/manipulated. The handle 130 may be comprised of at least one grip area 132. The grip area 132 may be textured with a recessed or raised texture or may be non-textured. The grip area 132 is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc.

The device 100 also has at least one jet line spool 150. At least one hose 154 is stored around the spool 150. The hose 154 is preferably any type of hose or jetter hose known in the art. The hose 154 can be wrapped/unwrapped around the spool 150 by turning at least one handle 152 clockwise or counterclockwise.

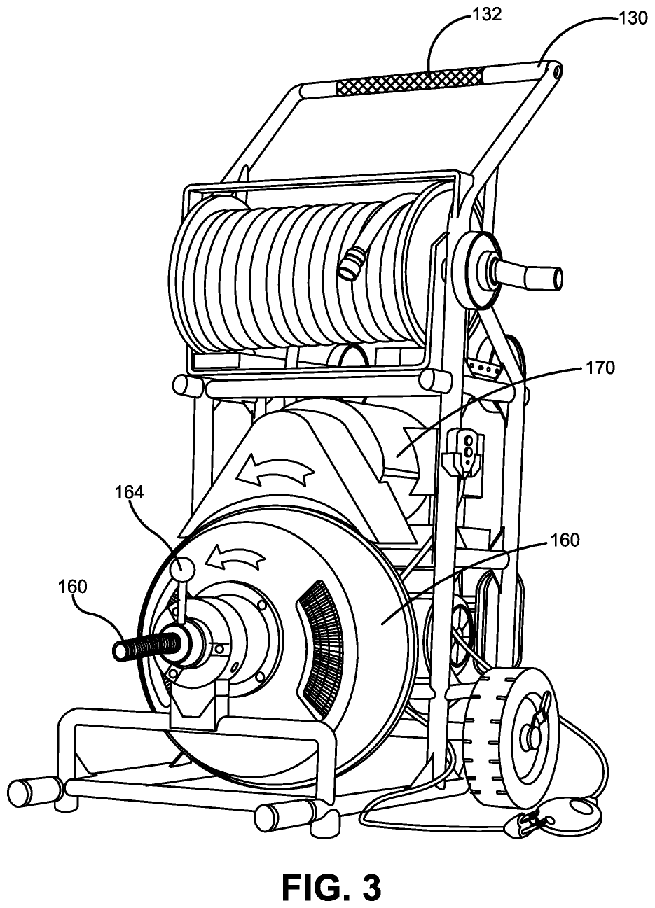

At least one snake auger line 160 is also stored on the frame 110, as seen in FIG. 3. The auger 160 is stored around at least one cable machine spool 162. The auger 160 can be wrapped/unwrapped from the spool 162 via at least one control 164 such as, but not limited to, a handle that can be rotated clockwise or counterclockwise. The auger 160 is used to remove roots, grease, or any other foreign stoppage inside a sewer/plumbing line.

The device 100 is also comprised of at least one motor 170. In one embodiment, both spools 150,162 are powered by the motor 170 such that the motor 170 can spin each spool 150,162 to wrap/unwrap the hose 154 and auger 160 from each spool 150,162. In one embodiment, the rotation of each spool 150,162 by the motor 170 (and all functions of the motor 170) can be controlled by at least one foot pedal 192 or at least one hand control 194. The pedal 192 and hand control 194 may also allow a user to switch between either spool 150,162 during use. Both the foot pedal 192 and hand control 194 can be stored on the frame 110 via at least one control holder 114. The motor 170 may receive power from at least one male or female 110v/240v power cord 190.

The device 100 may also be comprised of at least one pump 180. The pump 180 is used to increase water pressure from a water source that attaches to the jetter hose 154. The pump 180 may be powered by the motor 170. The increased water pressure from the pump 180 allows the water from the hose 154 to cut through any excess debris within a sewer/plumbing line, and flush said debris.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cable machine and jet line combination device” and “device” are interchangeable and refer to the cable machine and jet line combination device 100 of the present invention.

Notwithstanding the foregoing, the cable machine and jet line combination device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable machine and jet line combination device 100 as shown in the FIGS. are for illustrative purposes only, and that many other sizes and shapes of the cable machine and jet line combination device 100 are well within the scope of the present disclosure. Although the dimensions of the cable machine and jet line combination device 100 are important design parameters for user convenience, the cable machine and jet line combination device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable machine and jet line combination device comprising:
a frame;
a primary wheel;
a secondary wheel;
a handle;
a stair climbing roller;
a first spool comprised of a first handle;
a hose positioned around the first spool;
a second spool comprised of a second handle;
a snake auger positioned around the second spool;
a motor;
a pump;
a power cord; and
a hand control.

2. The cable machine and jet line combination device of claim 1, wherein the hose is comprised of a jetter hose.

3. The cable machine and jet line combination device of claim 1, wherein the pump increases water pressure within the jetter hose.

4. The cable machine and jet line combination device of claim 1, wherein the primary wheel attaches to an axle.

5. A cable machine and jet line combination device comprising:
a frame comprised of a roller guard;
a primary wheel comprised of a wheel lock;
a secondary wheel comprised of an adjustable frame;
a handle;
a stair climbing roller;
a first spool comprised of a first handle;
a hose positioned around the first spool;
a second spool comprised of a second handle;
a snake auger positioned around the second spool;
a motor;
a pump;
a power cord;
a hand control; and
a foot control.

6. The cable machine and jet line combination device of claim 5, wherein the hand control controls the motor and the pump.

7. The cable machine and jet line combination device of claim 5, wherein the foot control controls the motor and the pump.

8. The cable machine and jet line combination device of claim 5, wherein the second handle rotates the second spool.

9. The cable machine and jet line combination device of claim 5, wherein the first handle rotates the first spool.

10. A cable machine and jet line combination device comprising:
a frame comprised of a roller guard and a cover;
a primary wheel comprised of a wheel lock;
a secondary wheel comprised of an adjustable frame;
a handle comprised of a grip area;
a stair climbing roller;
a first spool comprised of a first handle;
a hose positioned around the first spool;
a second spool comprised of a second handle;
a snake auger positioned around the second spool;
a motor;
a pump;
a power cord;
a hand control; and
a foot control.

11. The cable machine and jet line combination device of claim 10, wherein the cover attaches to the frame via a first fastener.

12. The cable machine and jet line combination device of claim 10, wherein the cover is comprised of an indicia.

13. The cable machine and jet line combination device of claim 10, wherein the motor rotates the first spool.

14. The cable machine and jet line combination device of claim 10, wherein the motor rotates the second spool.

15. The cable machine and jet line combination device of claim 10, wherein the stair climber roller is comprised of a wheel.

16. The cable machine and jet line combination device of claim 10, wherein the stair climber roller is comprised of a belt.

17. The cable machine and jet line combination device of claim 10, wherein the frame is comprised of a holder for the hand control.

18. The cable machine and jet line combination device of claim 10, wherein the grip area is comprised of a non-slip material.

19. The cable machine and jet line combination device of claim 10, wherein the adjustable frame can be adjusted at a desired length via a second fastener.

20. The cable machine and jet line combination device of claim 10, wherein the wheel lock inhibits the rotation of the primary wheel.
